(19) United States
(12) Patent Application Publication
(10) Pub. No.: US 2023/0036675 A1
(43) Pub. Date: Feb. 2, 2023

(54) SAMPLING MODULE

(71) Applicant: InnoSpectra Corporation, Hsin-Chu (TW)

(72) Inventors: Fei-Peng Chang, Hsin-Chu (TW); Kuo-Sheng Huang, Hsin-Chu (TW); Hsi-Pin Li, Hsin-Chu (TW)

(73) Assignee: InnoSpectra Corporation, Hsin-Chu (TW)

(21) Appl. No.: 17/834,919

(22) Filed: Jun. 7, 2022

(30) Foreign Application Priority Data
Jul. 30, 2021 (CN) 202121769677.3

(51) Int. Cl. G01J 3/02; G02B 5/10; G02B 19/00; G02B 5/00

(52) U.S. Cl. CPC G01J 3/0297; G02B 5/10; G02B 19/0019; G01J 3/0216; G02B 5/003; G02B 19/0085; G01J 3/0286; G01J 3/0208

(57) ABSTRACT

A sampling module for providing an illumination beam onto an object and collecting a measurement beam reflected thereby to at least one measurement device is provided. The sampling module includes at least one illumination module, a light collecting element, and at least one light receiving module. The illumination module provides the illumination beam. The light collecting element has a first opening and an internal space. The illumination module is disposed in the first opening. The illumination beam is transmitted to the object in the internal space. The light receiving module is connected to the light collecting element and includes a case and a lens set. A distance between the sampling module and the object is greater than 0 mm. The measurement beam is transmitted by the object through the lens set to be incident onto the measurement device.

### CROSS-REFERENCE TO RELATED APPLICATION

This application claims the priority benefit of China application serial no. 202121769677.3, filed on Jul. 30, 2021. The entirety of the above-mentioned patent application is hereby incorporated by reference herein and made a part of this specification.

### BACKGROUND

### Technical Field

The disclosure relates to an optical module, and particularly relates to a sampling module for a spectrometer.

### Description of Related Art

The spectrometer is widely used in material analysis applications. Usually, the engine of the spectrometer may be matched with different sampling modules, such as transmissive, reflective, or fiber input modules. Different sampling modules and the engine of the spectrometer constitute the overall optical system of the spectrometer. However, the size of the light source of the conventional diffuse-reflective sampling module is relatively large (with a diameter of about 22 mm), and there is a set angle with the sample to be measured. Therefore, for the sampling module, the volume becomes very large and occupies a lot of space. On the other hand, the conventional diffuse-reflective sampling module has poor light collection efficiency after diffuse reflection, thereby causing the light collection efficiency and the signal-to-noise ratio (SNR) of the spectrometer to decrease.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a sampling module, which can reduce the overall volume of the sampling module and increase the sampling range of the sampling module while preventing stray light from entering a measurement device to obtain good measurement quality.

Other objectives and advantages of the disclosure may be further understood from the technical features disclosed in the disclosure.

In order to achieve one, a part, or all of the above objectives or other objectives, the disclosure provides a sampling module for providing an illumination beam onto an object and collecting a measurement beam reflected by the object to at least one measurement device. The sampling module includes at least one illumination module, a light collecting element, and at least one light receiving module. The at least one illumination module provides the illumination beam. The light collecting element has a first opening and an internal space, and the at least one illumination module is disposed in the first opening. The illumination beam is transmitted to the object in the internal space. The at least one light receiving module is connected to the light collecting element. The at least one light receiving module includes a case and a lens set disposed in the case. A distance between the sampling module and the object is greater than 0 mm. The measurement beam is transmitted by the object through the lens set to be incident onto the at least one measurement device.

Based on the above, the embodiments of the disclosure have at least one of the following advantages or effects. In the sampling module of the disclosure, by combining the illumination module and the light collecting element, the volume of the illumination module can be further reduced while improving the usage efficiency of the illumination beam. In this way, the overall volume of the sampling module can be further reduced and the sampling range of the sampling module can be increased. In addition, the sampling module can also further enable the measurement beam reflected by the object to be collimated while preventing the stray light from entering the measurement device by combining the light collecting element and the light receiving module. In this way, good measurement quality can be further obtained.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic diagram of a sampling module according to an embodiment of the disclosure.

FIG. 2 is a three-dimensional schematic diagram of the sampling module of FIG. 1.

FIG. 3 is a comparison diagram between efficiency curves of receiving light beams by a conventional contact sampling module and by the sampling module of the embodiment of FIG. 1.

FIG. 4 is a comparison diagram between measured spectrum curves of receiving light beams by the conventional contact sampling module and by the sampling module of the embodiment of FIG. 1.

FIG. 5 is a three-dimensional schematic diagram of a sampling module according to another embodiment of the disclosure.

FIG. 6 is a three-dimensional schematic diagram of a sampling module according to another embodiment of the disclosure.

FIG. 7 is a cross-sectional schematic diagram of a sampling module according to another embodiment of the disclosure.

FIG. 8 is a cross-sectional schematic diagram of a sampling module according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

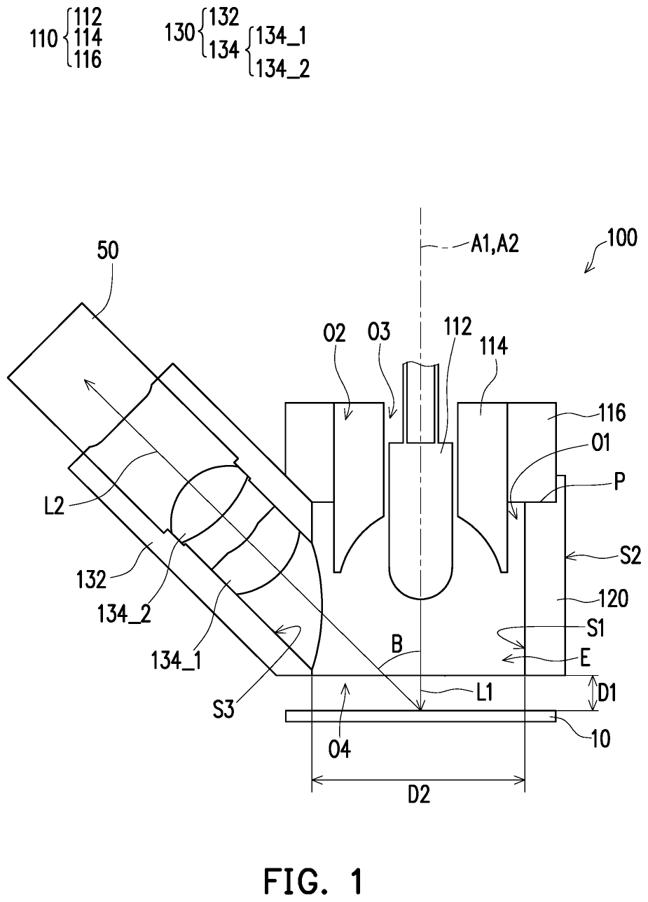

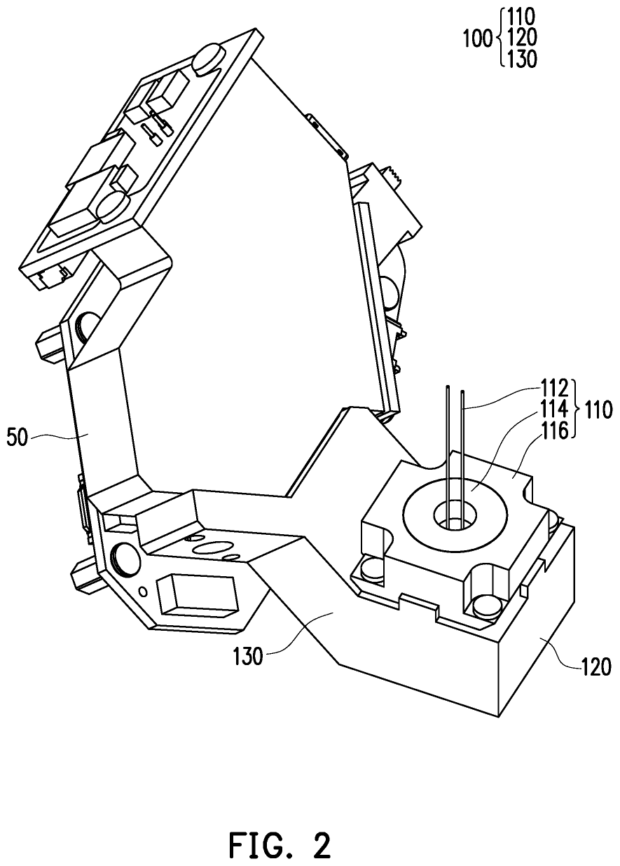

FIG. 1 is a cross-sectional schematic diagram of a sampling module according to an embodiment of the disclosure. FIG. 2 is a three-dimensional schematic diagram of the sampling module of FIG. 1. Please refer to FIG. 1 and FIG. 2. The embodiment provides a sampling module 100 for providing an illumination beam L1 onto an object 10 and collecting a measurement beam L2 with characteristics of the object 10 reflected by the object 10 to be transmitted to at least one measurement device 50. In the embodiment, the number of the measurement device 50 is one, and the measurement device 50 is, for example, a spectrometer body to perform optical analysis on the measurement beam L2 received by the sampling module 100. In addition, a distance D1 between the sampling module 100 and the object 10 is greater than 0 mm. In other words, the sampling module 100 provided by the embodiment is a non-contact device. In a preferred embodiment, the distance D1 between the sampling module 100 and the object 10 is greater than 5 mm.

In detail, the sampling module 100 includes at least one illumination module 110, a light collecting element 120, and at least one light receiving module 130. The illumination module 110 is disposed on the light collecting element 120, and the illumination beam L1 is transmitted by the illumination module 110 to the light collecting element 120 to be further transmitted to the object 10. The object 10 reflects the measurement beam L2 to the light receiving module 130 to be further transmitted to the measurement device 50.

The illumination module 110 is configured to provide the illumination beam L1 to the object 10. In the embodiment, the number of the illumination module 110 is one, but the disclosure is not limited thereto. The light collecting element 120 has a first opening O1 and an internal space E. The illumination module 110 is disposed in the first opening O1, and the illumination beam L1 is transmitted to the object 10 in the internal space E. Specifically, the illumination module 110 includes a light emitting element 112, a cup-shaped reflector 114, and a base 116. The light emitting element 112 is configured to provide the illumination beam L1. In the embodiment, the light emitting element 112 is, for example, a light emitting diode (LED), and the wavelength of the illumination beam L1 may be between 400 nm and 2500 nm, but the disclosure is not limited thereto. The base 116 is disposed on a top portion of the light collecting element 120 and is configured to carry the light emitting element 112 and the cup-shaped reflector 114. The base 116 has a second opening O2, and the light emitting element 112 and the cup-shaped reflector 114 are disposed in the second opening O2. The cup-shaped reflector 114 has a third opening O3, and the light emitting element 112 is disposed in the third opening O3. Therefore, since the illumination beam L1 emitted by the light emitting element 112 is emitted toward any direction, the illumination directivity may be improved by the reflective guiding effect of the cup-shaped reflector 114. In the embodiment, an optical axis A1 of the light emitting element 112 and a central axis A2 of the cup-shaped reflector 114 are coaxial to achieve precise assembly, but the disclosure is not limited thereto.

In a different embodiment, the number of the illumination module 110 may be multiple. Specifically, a combination of multiple light emitting elements 112, the cup-shaped reflector 114, and the base 116 may be provided on the top portion of the light collecting element 120 at the same time. Alternatively, a combination of multiple light emitting elements 112 and the cup-shaped reflector 114 may be provided in the base 116 at the same time, and the base 116 is provided on the top portion of the light collecting element 120. In this way, the illumination intensity or uniformity of the illumination beam L1 may be further enhanced. In another different embodiment, the light emitting element 112 may be selected as light sources that provide light beams with different wavelengths to facilitate measurement of different wavebands, but the disclosure is not limited thereto.

The light collecting element 120 is a hollow cylindrical case whose top end is connected to the base 116 of the illumination module 110. In the embodiment, the light collecting element 120 has a carrying platform P with height lower than an outer wall S2 and configured to carry a bottom portion of the base 116. In other words, the light emitting element 112 is located inside the cup-shaped reflector 114, and the cup-shaped reflector 114 is located inside the light collecting element 120, so that the light emitting element 112 and the cup-shaped reflector 114 can have better positions to generate optimal light emission. In addition, an inner wall S1 of the light collecting element 120 is a smooth reflective surface, so the usage efficiency of the illumination beam L1 can be improved. The light collecting element 120 has a light outlet O4 relative to the first opening O1, and a diameter D2 of the light outlet O4 is less than 25 mm. In the embodiment, the diameter of the light collecting element 120 is 16 mm, and the distance D1 from the object 10 is 8 mm. Therefore, the sampling range of the sampling module 100 can be increased.

The light receiving module 130 is connected to the light collecting element 120. In the embodiment, the light collecting element 120 and a case 132 of the light receiving module 130 are integrally formed, but the disclosure is not limited thereto. An angle B is included between an extending axial direction (same as the optical axis A1) of the light receiving module 130 and an extending axial direction of the light collecting element 120, and the angle B is greater than or equal to 25 degrees and less than or equal to 65 degrees. In the embodiment, the angle B is 45 degrees.

Specifically, the light receiving module 130 includes the case 132 and a lens set 134 disposed in the case 132. An inner wall S3 of the case 132 is a light absorbing surface with an absorbance of greater than or equal to 2. For example, the surface of the inner wall S3 may be made by surface anodization. Therefore, when the measurement beam L2 is transmitted by the object 10 into the light receiving module 130, the inner wall S3 of the case 132 may absorb stray light to prevent the stray light from entering the measurement device 50.

The measurement beam L2 is reflected by the object 10 to be incident onto the measurement device 50 through the lens set 134. In detail, the lens set 134 includes a first lens 134_1 and a second lens 134_2. The first lens 134_1 is located between the second lens 134_2 and the light collecting element 120. In the embodiment, the first lens 134_1 is a concave-convex lens with a concave surface facing the second lens 134_2, and the second lens 134_2 is a biconvex lens. In the embodiment, the receivable wavelength range of the first lens 134_1 and the second lens 134_2 is between 400 nm and 2500 nm.

Therefore, compared with the conventional sampling module, the sampling module 100 of the embodiment can further reduce the volume of the illumination module 110 while improving the usage efficiency of the illumination beam L1 by combining the illumination module 110 and the light collecting element 120. In this way, the overall volume of the sampling module 100 can be further reduced and the sampling range of the sampling module 100 can be increased. In addition, the sampling module 100 of the embodiment can also further enable the measurement beam L2 reflected by the object 10 to be collimated while preventing the stray light from entering the measurement device 50 by combining the light collecting element 120 and the light receiving module 130. In this way, good measurement quality can be further obtained.

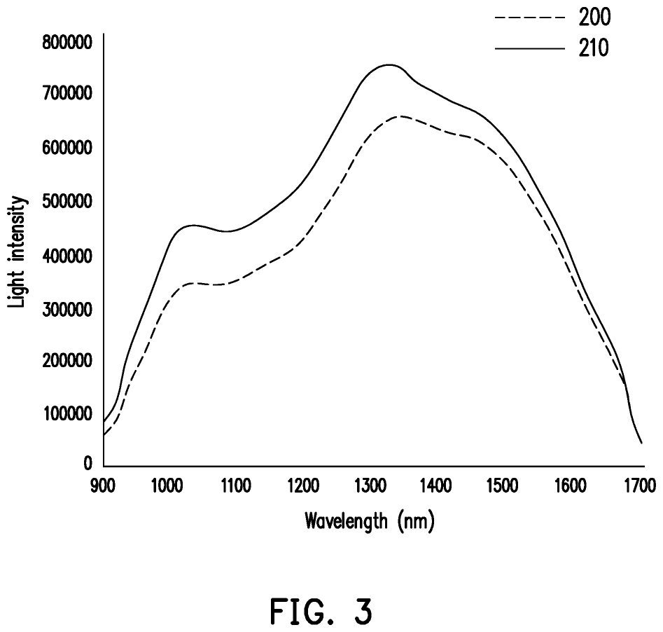

FIG. 3 is a comparison diagram between efficiency curves of receiving light beams by a conventional contact sampling module and by the sampling module of the embodiment of FIG. 1. Please refer to FIG. 3. A curve 200 represents a light intensity versus wavelength graph of light entering a measurement device using the conventional contact sampling module (that is, adopting contact measurement). A curve 210 represents a light intensity versus wavelength graph of light entering the measurement device using the sampling module 100 of the embodiment of FIG. 1. It can be seen from FIG. 3 that non-contact measurement using the sampling module 100 of the embodiment of FIG. 1 may still obtain the intensity that is about 15% higher than using the conventional contact sampling module. Therefore, the sampling module 100 of the embodiment of FIG. 1 may exceed the light collection efficiency of the contact measurement.

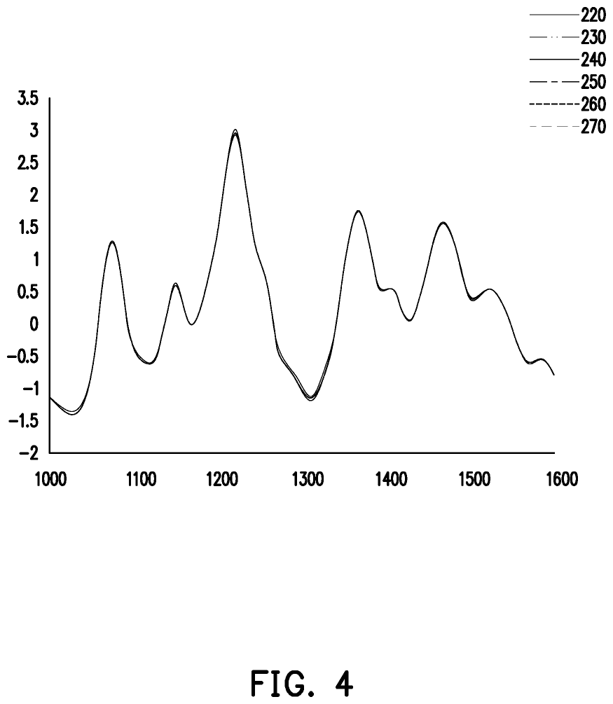

FIG. 4 is a comparison diagram between measured spectrum curves of receiving light beams by the conventional contact sampling module and by the sampling module of the embodiment of FIG. 1. Please refer to FIG. 4. A curve 230 represents an absorbance versus wavelength graph of light entering the measurement device using the conventional contact sampling module (that is, adopting the contact measurement). Curves 220, 230, 240, 250, 260, and 270 respectively represent absorbance versus wavelength graphs of light entering the measurement device using the sampling module 100 of the embodiment of FIG. 1 when deviations are −2 mm, −1 mm, 0 mm, +1 mm, and +2 mm based on a distance of 8 mm. It can be seen from FIG. 3 that for the non-contact measurement using the sampling module 100 of the embodiment of FIG. 1, even if there is a deviation (within ±2 mm) in the depth of field, the measured spectrums of the object 10 all overlap and also overlap with the material spectrums measured by the conventional contact sampling module. In other words, it means that although the distance between the sampling module 100 and the object 10 is 8 mm, effective spectrums of the object 10 may still be obtained within the range of the distance and the deviation of ±2 mm.

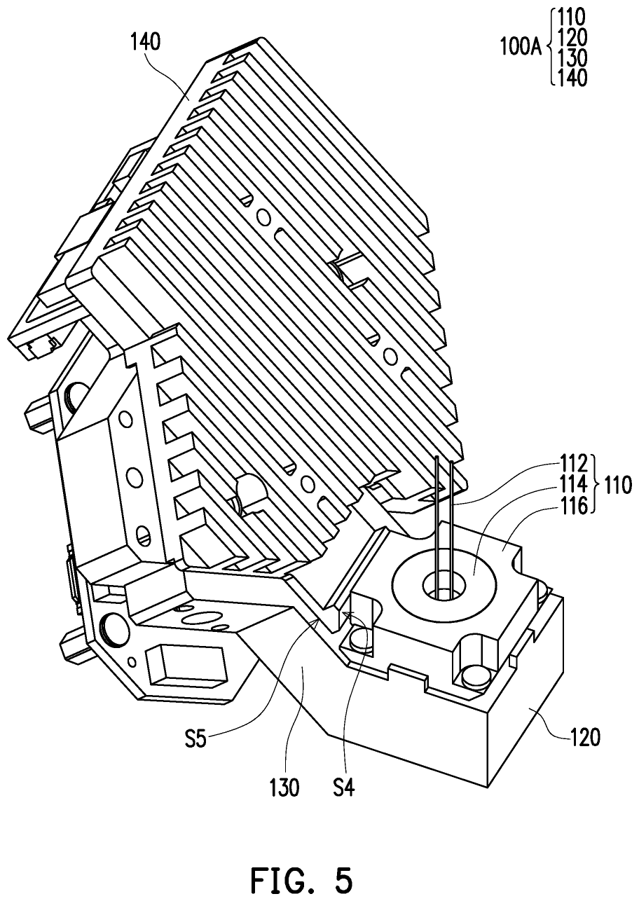

FIG. 5 is a three-dimensional schematic diagram of a sampling module according to another embodiment of the disclosure. Please refer to FIG. 5. A sampling module 100A of the embodiment is similar to the sampling module 100 shown in FIG. 2. The difference between the two is that in the embodiment, the sampling module 100A further includes a heat dissipating fin 140. The heat dissipating fin 140 is supported by the light collecting element 120 and the case 132 of the light receiving module 130, and an upper cover of the measurement device 50. The material of the heat dissipating fin 140 is, for example, an aluminum alloy with high conductivity, and the heat dissipating fin 140 has an anodized black light absorbing surface with an absorbance of 2 or more to prevent external light from entering the measurement device 50. Specifically, the heat dissipating fin 140 has a first plane S4 and a second plane S5. The first plane S4 is supported by the illumination module 110, and the second plane S5 is supported by the light receiving module 130. Therefore, the heat dissipating effect of the illumination module 110 and the light receiving module 130 can be improved to prevent heat energy from being transmitted to the measurement device 50. In this way, in addition to improving the overall heat dissipating effect, the light emitting element 112 may also use a high-wattage light bulb, thereby improving the signal-to-noise ratio of the measurement device 50. In the embodiment, the heat dissipating fin 140 is used as a partial case of the measurement device 50, as shown in FIG. 5. Therefore, the external light may be further prevented from entering the measurement device 50 while protecting the measurement device 50 from dust pollution.

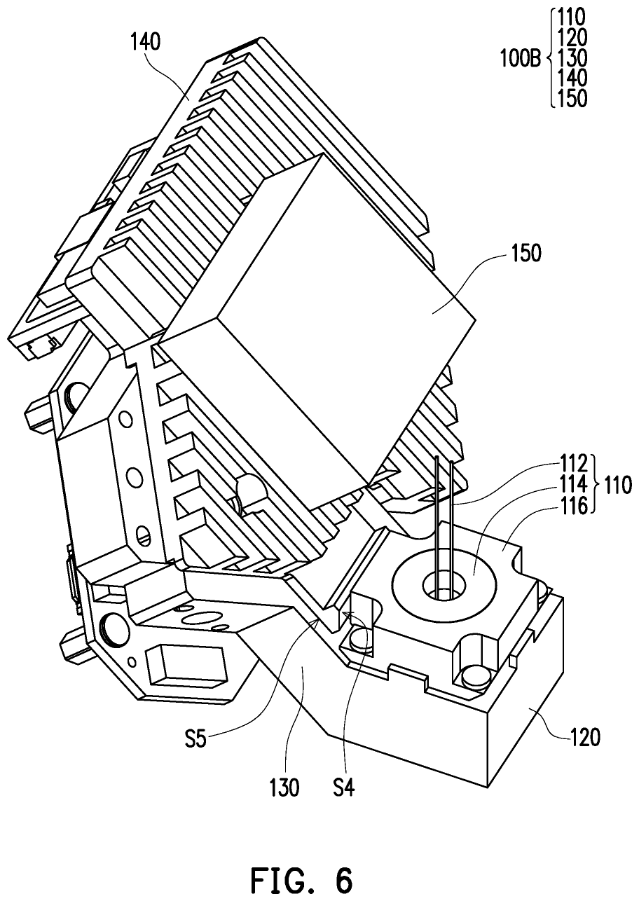

FIG. 6 is a three-dimensional schematic diagram of a sampling module according to another embodiment of the disclosure. Please refer to FIG. 6. A sampling module 100B of the embodiment is similar to the sampling module 100A shown in FIG. 5. The difference between the two is that in the embodiment, the sampling module 100B further includes a heat dissipating element 150, which is disposed on the heat dissipating fin 140. In the embodiment, the heat dissipating element 150 is, for example, a heat dissipating fan, which uses forced convection to quickly dissipate heat energy generated by the illumination module 110 to prevent the heat energy from affecting the performance of the measurement device 50. In another embodiment, the heat dissipating element 150 may replace the heat dissipating fan with a cooling chip to reduce the influence of airflow disturbance on the measurement environment, but the disclosure is not limited thereto.

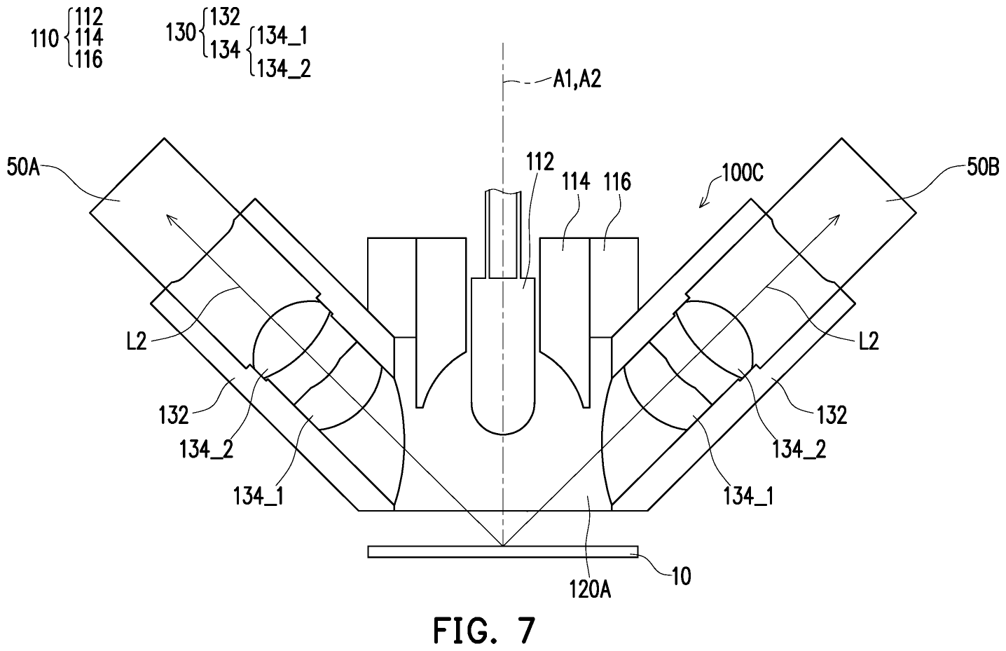

FIG. 7 is a cross-sectional schematic diagram of a sampling module according to another embodiment of the disclosure. Please refer to FIG. 7. A sampling module 100C of the embodiment is similar to the sampling module 100 shown in FIG. 1. The difference between the two is that in the embodiment, the number of the light receiving module 130 is multiple, and the number of measurement devices 50A and 50B is the same as the number of the light receiving module 130. For example, the number of the light receiving module 130 is two, and the number of the measurement devices 50A and 50B is also two. The two light receiving modules 130 are symmetrically distributed on a light collecting element 120A, and the two measurement devices 50A and 50B are respectively connected to the two light receiving modules 130. In addition, wavebands of light beams measured by the two measurement devices 50A and 50B are different. For example, the waveband measured by the measurement device 50A is 900 nm to 1700 nm, and the waveband measured by the measurement device 50B is 1350 nm to 2150 nm, but the disclosure is not limited thereto. In this way, the diversity of measurement may be further increased.

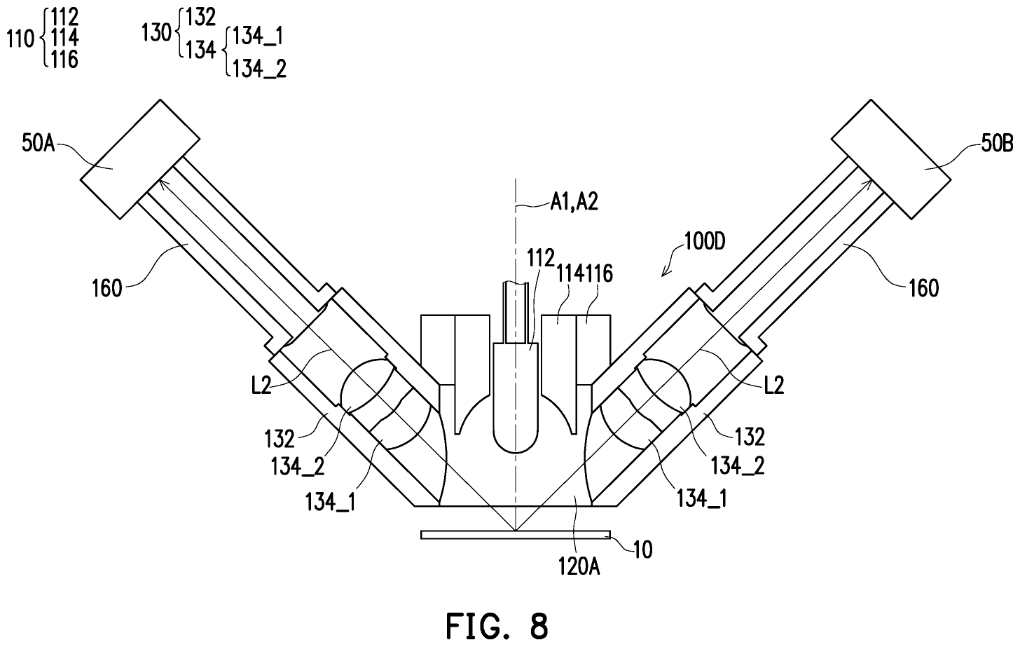

FIG. 8 is a cross-sectional schematic diagram of a sampling module according to another embodiment of the disclosure. Please refer to FIG. 8. A sampling module 100D of the embodiment is similar to the sampling module 100C shown in FIG. 7. The difference between the two is that in the embodiment, the sampling module 100D further includes multiple conductive elements 160, which are respectively connected between the corresponding light receiving modules 130 and the measurement devices 50A and 50B. The conductive elements 160 are, for example, optical fibers and are connected to the light receiving modules 130 and the measurement devices 50A and 50B by using a subminiature version A (SMA) adapter. In this way, the measurement devices 50A and 50B may be further disposed to be away from the sampling module 100D, so as to be applied in different environments.

In summary, the embodiments of the disclosure have at least one of the following advantages or effects. In the sampling module of the disclosure, by combining the illumination module and the light collecting element, the volume of the illumination module can be further reduced while improving the usage efficiency of the illumination beam. In this way, the overall volume of the sampling module can be further reduced and the sampling range of the sampling module can be increased. In addition, the sampling module can also further enable the measurement beam reflected by the object to be collimated while preventing the stray light from entering the measurement device by combining the light collecting element and the light receiving module. In this way, good measurement quality can be further obtained.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A sampling module, comprising: at least one illumination module, a light collecting element, and at least one light receiving module, wherein the sampling module is configured to provide an illumination beam onto an object and collect a measurement beam reflected by the object to at least one measurement device, wherein
the at least one illumination module provides the illumination beam;
the light collecting element has a first opening and an internal space, the at least one illumination module is disposed in the first opening, and the illumination beam is transmitted to the object in the internal space; and
the at least one light receiving module is connected to the light collecting element, and the at least one light receiving module includes a case and a lens set disposed in the case, wherein a distance between the sampling module and the object is greater than 0 mm, and the measurement beam is transmitted by the object through the lens set to be incident onto the at least one measurement device.

2. The sampling module according to claim 1, wherein the at least one illumination module comprises a light emitting element, a cup-shaped reflector and a base, the base is disposed on a top portion of the light collecting element, the base has a second opening, the cup-shaped reflector is disposed in the second opening, the cup-shaped reflector has a third opening, the light emitting element is disposed in the third opening, and the light emitting element is configured to provide the illumination beam.

3. The sampling module according to claim 2, wherein an optical axis of the light emitting element and a central axis of the cup-shaped reflector are coaxial.

4. The sampling module according to claim 2, wherein a number of the at least one illumination module is plural.

5. The sampling module according to claim 1, wherein the light collecting element is a hollow cylindrical case, and an inner wall of the light collecting element is a smooth reflective surface.

6. The sampling module according to claim 1, wherein the light collecting element has a light outlet relative to the first opening, and a diameter of the light outlet is less than 25 mm.

7. The sampling module according to claim 1, wherein the distance between the sampling module and the object is greater than 5 mm.

8. The sampling module according to claim 1, wherein an inner wall of the case of the at least one light receiving module is a light absorbing surface with an absorbance of greater than or equal to 2.

9. The sampling module according to claim 1, wherein the light collecting element and the case of the at least one light receiving module are integrally formed.

10. The sampling module according to claim 1, wherein an angle is included between an extending axial direction of the at least one light receiving module and an extending axial direction of the light collecting element, and the angle is greater than or equal to 25 degrees and less than or equal to 65 degrees.

11. The sampling module according to claim 1, wherein the lens set comprises a first lens and a second lens, and the first lens is located between the second lens and the light collecting element.

12. The sampling module according to claim 11, wherein the first lens is a concave-convex lens, and the second lens is a biconvex lens.

13. The sampling module according to claim 1, wherein the sampling module further comprises a heat dissipating fin, the heat dissipating fin has a first plane and a second plane, the first plane is supported by the at least one illumination module, and the second plane is supported by the at least one light receiving module.

14. The sampling module according to claim 13, wherein the heat dissipating fin is used as a partial case of the at least one measurement device.

15. The sampling module according to claim 13, wherein the sampling module further comprises a heat dissipating element disposed on the heat dissipating fin, and the heat dissipating element is a heat dissipating fan or a cooling chip.

16. The sampling module according to claim 1, wherein a number of the at least one light receiving module is plural, a number of the at least one measurement device is the same as the number of a plurality of light receiving modules, the plurality of light receiving modules are symmetrically distributed on the light collecting element, and the plurality of measurement devices are respectively connected to the plurality of light receiving modules.

17. The sampling module according to claim 16, wherein wavebands of light beams measured by the plurality of measurement devices are different.

18. The sampling module according to claim 16, wherein the sampling module further comprises a plurality of conductive elements respectively connected between the corresponding plurality of light receiving modules and plurality of measurement devices.
